(19) United States
(12) Patent Application Publication
(10) Pub. No.: US 2025/0376354 A1
(43) Pub. Date: Dec. 11, 2025

(54) ELEVATOR CAR CEILING SYSTEM, ELEVATOR CAR AND ELEVATOR SYSTEM

(71) Applicant: Otis Elevator Company, Farmington, CT (US)

(72) Inventors: Yingjin Zhang, Shanghai (CN); Weihua Shen, Shanghai (CN)

(21) Appl. No.: 19/227,552

(22) Filed: Jun. 4, 2025

(30) Foreign Application Priority Data
Jun. 7, 2024 (CN) 202410740968.1

(51) Int. Cl. B66B 11/02

(52) U.S. Cl. CPC B66B 11/0246

(57) ABSTRACT

An elevator car ceiling system, an elevator car and an elevator system. The elevator car ceiling system includes a ceiling panel, arranged below a car roof of an elevator car and having a normal state and a folded state, the ceiling panel includes a first panel and a second panel connected to each other, and the first panel and the second panel are folded in the folded state to provide an opening to the car roof; and an operating device, arranged inside the elevator car and connected to the ceiling panel, the operating device is configured for operating to cause the ceiling panel to enter the folded state from the normal state, or to return to the normal state from the folded state.

### FOREIGN PRIORITY

This application claims priority to Chinese Patent Application No. 202410740968.1, filed Jun. 7, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to an elevator car ceiling system, an elevator car, and an elevator system.

### BACKGROUND OF THE INVENTION

An elevator car typically operates in an elevator shaft and transports passengers, goods, etc. that it carries to target landings. When an elevator system encounters abnormalities or malfunctions during use, it is possible that mechanics will enter the top area of the elevator car for equipment inspection and maintenance, or passengers will escape through the safety exit on the car roof. In addition, when elevator equipment undergoes regular inspection and maintenance or when installing devices such as smoke sensors, cameras, lighting fixtures, etc. in the elevator car, it is often necessary to first open the ceiling panel and then perform the corresponding operations.

For example, FIGS. 1 and 2 schematically illustrate a partial layout of the interior space of an elevator car and the scene of a mechanic performing operations. A work platform 3 is installed above a ceiling panel 1 of the elevator car. The ceiling panel 1 adopts an integrated design and can be flipped down from its original normal position by operating a switch 2, so that an opening leading to the car roof is provided, thus allowing the mechanic P to lower the work platform 3. Then, the mechanic P can land on the work platform 3 and adjust the height as needed to perform the desired operations. For example, the mechanic P can operate a device 4 located on the upper side wall of the car to perform operations related to the operation of the elevator car, such as controlling the start and stop of the elevator car, detecting or querying the current or historical operation information of the elevator car, and the like. The mechanic P usually needs to use auxiliary tools such as ladders and operating rods to operate the switch 2 to control the opening above the ceiling panel 1.

The contents described in this section are for the purpose of facilitating the understanding of the technical solutions of the present disclosure and should not be considered as belonging to the prior art merely because of their inclusion in this section.

### SUMMARY OF THE INVENTION

In view of the foregoing, the present disclosure provides an elevator car ceiling system, an elevator car, and an elevator system, so as to solve or at least alleviate one or more of the aforementioned problems and other problems in the prior art.

Firstly, according to a first aspect of the present disclosure, an elevator car ceiling system is provided, which comprises: a ceiling panel, arranged below a car roof of an elevator car and having a normal state and a folded state, wherein the ceiling panel comprises a first panel and a second panel connected to each other, and the first panel and the second panel are folded in the folded state to provide an opening to the car roof; and an operating device, arranged inside the elevator car and connected to the ceiling panel, wherein the operating device is configured for operating to cause the ceiling panel to enter the folded state from the normal state, or to return to the normal state from the folded state.

In an elevator car ceiling system according to the present disclosure, optionally, the operating device comprises: a first roller, fixed to one of the first panel and the second panel; a second roller, arranged on the same side of the elevator car as the first roller, and arranged adjacent to the other of the first panel and the second panel and fixed relative to the elevator car; and a cable, a first end of which is fixed on the first roller, and a second end of which is arranged in an interior space of the elevator car for operation after winding around the second roller.

In an elevator car ceiling system according to the present disclosure, optionally, the first panel and the second panel are hingedly connected to each other, and when the first roller is moved in the direction of the second roller by a stretching operation at the second end of the cable, the first panel and the second panel are folded downwardly or upwardly, causing the ceiling panel to enter the folded state.

In an elevator car ceiling system according to the present disclosure, optionally, the second roller is fixed to a ceiling frame of the elevator car, and the first roller is rollably arranged on the ceiling frame.

In an elevator car ceiling system according to the present disclosure, optionally, the operating device further comprises: a third roller, fixed to said one of the first panel and the second panel, and arranged on opposite sides of the elevator car from the first roller; and/or a fourth roller, fixed to said the other of the first panel and the second panel, and arranged on opposite sides of the elevator car from the second roller.

In an elevator car ceiling system according to the present disclosure, optionally, the third roller and the fourth roller are rollably arranged on the ceiling frame of the elevator car.

In an elevator car ceiling system according to the present disclosure, optionally, the first panel and the second panel are hingedly connected to each other and the second end of the cable is fixed in the interior space of the elevator car, causing both the first panel and the second panel remain unfolded in the normal state.

In an elevator car ceiling system according to the present disclosure, optionally, the second end is fixed inside a car operation panel box of the elevator car.

In an elevator car ceiling system according to the present disclosure, optionally, an operating handle is provided inside the car operation panel box and the second end is fixed to the operating handle, or a motor and a control member for controlling operation of the motor are provided inside the car operation panel box and the second end is connected to an output end of the motor.

In an elevator car ceiling system according to the present disclosure, optionally, the first panel and the second panel are arranged along a transverse or longitudinal direction of the elevator car, and/or a width of the first panel is the same as a width of the second panel.

In addition, according to a second aspect of the present disclosure, an elevator car configured with an elevator car ceiling system according to any of the above is also provided.

Furthermore, according to a third aspect of the present disclosure, an elevator system configured with one or more elevator cars as described above is further provided.

The elevator car ceiling system according to the present disclosure is compact in structure, and easy to manufacture, assemble and use, making it very convenient to open the top area of the elevator car after operation for equipment installation, maintenance, inspection, and personnel evacuation. The adoption of the solutions of the present disclosure does not require the use of special or additional tools to open the ceiling panel, and thus can bring great convenience to elevator system maintenance and management. The ceiling system according to the present disclosure has a wide range of applications, which can be used in various types of elevator cars such as light elevator cars, low-height elevator cars, and heavy-load elevator cars.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a schematic side view of a partial layout of the interior space of an elevator car.

FIG. 2 is a schematic side view of a mechanic entering the opening above the elevator car ceiling panel shown in FIG. 1 to perform operations.

FIG. 3 is a three-dimensional schematic diagram of an example of an elevator system that can adopt various embodiments of the present disclosure.

FIG. 4 is a partial perspective structural schematic diagram of an embodiment of an elevator car according to the present disclosure, where an embodiment of an elevator car ceiling system already arranged in the elevator car is also shown.

FIG. 5 is a partial schematic side view where the first panel in the embodiment of an elevator car ceiling system shown in FIG. 4 is installed.

FIG. 6 is a partial schematic side view where the embodiment of an elevator car ceiling system shown in FIG. 4 is in a normal state.

FIG. 7 is a partial schematic side view showing the process of the embodiment of an elevator car ceiling system shown in FIG. 4 changing from the normal state to the folded state.

FIG. 8 is another partial schematic side view showing the process of the embodiment of an elevator car ceiling system shown in FIG. 4 changing from the normal state to the folded state.

### DETAILED DESCRIPTION OF THE INVENTION

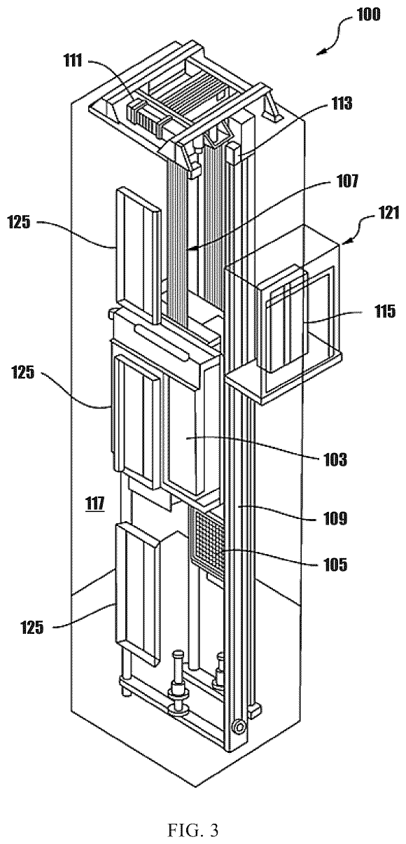

FIG. 3 is a perspective view of an elevator system 100 including an elevator car 103, a counterweight 105, a tension member 107, a guide rail 109, a machine 111, a position reference system 113, and an elevator controller 115. The elevator car 103 is configured with an example of an elevator car ceiling system as shown in FIG. 4, which will be described later. The elevator car 103 and counterweight 105 are connected to each other by the tension member 107. The tension member 107 may include or be configured as, for example, steel belts (e.g., coated-steel belts) and/or ropes (e.g., steel cables). The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111. The machine 111 is configured to control movement between the elevator car 103 and the counterweight 105. The machine 111 may include a motor or similar driving mechanism to provide operating power to elevator system 100, and such elevator driving devices are often referred to as traction machines, winches, etc. in practical applications. The position reference system 113 may be mounted on a fixed part at the top of the elevator shaft 117, such as on a support or guide rail, and may be configured to provide position signals related to a position of the elevator car 103 within the elevator shaft 117. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc.

The controller 115 is located in a controller room 121 of the elevator shaft 117 and is configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 100. For example, the controller may be located remotely or in the cloud.

Although shown and described with a roping system including tension member 107, elevator systems that employ other methods and mechanisms of moving an elevator car within an elevator shaft may employ embodiments of the present disclosure. For example, embodiments of the present disclosure may be employed in ropeless elevator systems using self-propelled elevator cars (e.g., elevator cars equipped with friction wheels, pinch wheels or traction wheels), or embodiments of the present disclosure may also be employed in ropeless elevator systems using a linear motor or a hydraulic lift to impart motion to an elevator car. It should be appreciated that the elevator system shown in FIG. 3 is only a non-limiting example presented for illustrative and explanatory purposes, and other elevator systems can be configured with the elevator car and ceiling system disclosed herein. For the sake of simplification, identical or similar components and features may only be indicated in one or several locations within the same drawing. Technical terms such as “first”, “second”, “third” and “fourth” are only used for the purpose of distinguishing and are not intended to indicate the order and relative importance thereof. The technical term “connect” means the realization of connection in a direct or an indirect manner.

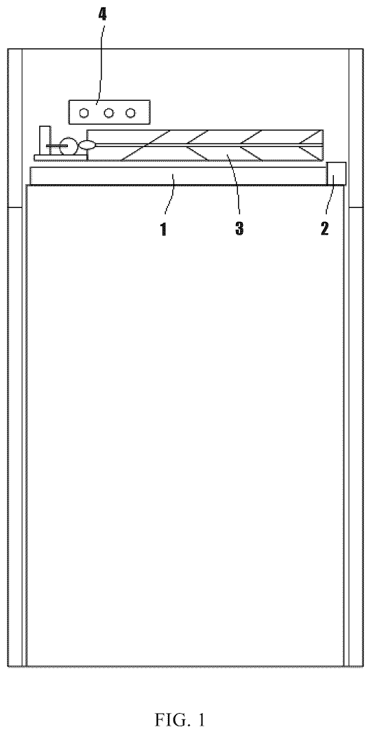

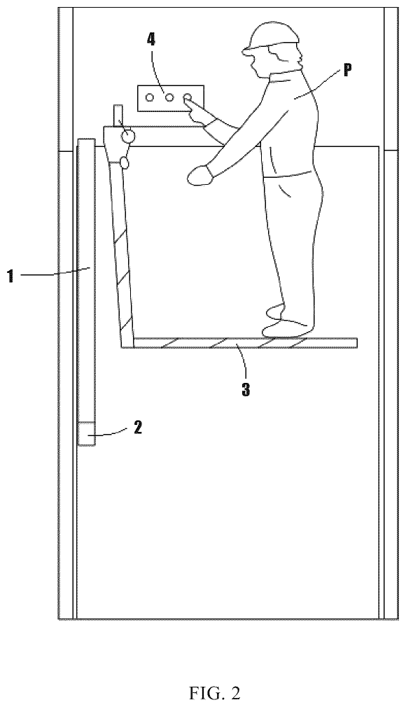

As shown in FIG. 4, as exemplarily used herein, the ceiling system inside the elevator car 103 may include a ceiling panel 10 and an operating device 20. The ceiling panel 10 is arranged below the car roof of the elevator car 103 and may include a first panel 11 and a second panel 12, which are typically configured to have the same width. According to different application needs, one, two, or more hinge members 14 may be used for the hinged connection of the first panel 11 and the second panel 12. In the normal state, the first panel 11 and the second panel 12 of the ceiling panel 10 can be in an unfolded arrangement as shown in FIGS. 4 and 6, so that by arranging the first panel 11 and the second panel 12 of the ceiling panel 10 above the interior space 104 of the elevator car 103, they can provide shielding and decoration effects on the car roof space. Such a ceiling panel is also commonly referred to as the ceiling. If the first panel 11 and the second panel 12 are folded, that is, when the ceiling panel 10 is in a folded state and at least a part of the originally covered area is opened, an opening to the car roof can be provided. Therefore, mechanics can enter the upper space for installation, maintenance, inspection, escape from the safety exit of the car roof, and other possible operations. For example, the mechanics may perform corresponding operations on the work platform arranged above the ceiling panel as shown in FIGS. 1 and 2.

The operating device 20 may be used to change the state of the ceiling panel 10, that is, to change the ceiling panel 10 from its normal state during normal use to the folded state, or to change the ceiling panel 10 from the folded state to the normal state. By way of exemplary illustration, as used exemplarily herein, the operating device 20 can be configured to include rollers 21, 22, 23, 24, and cables 25.

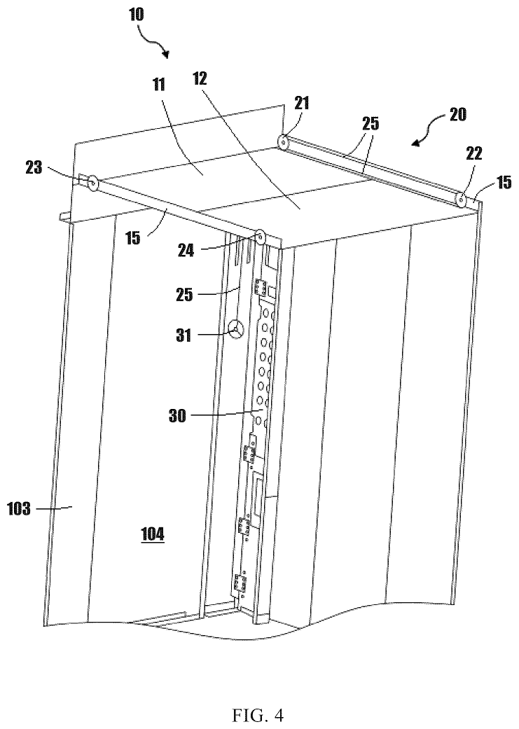

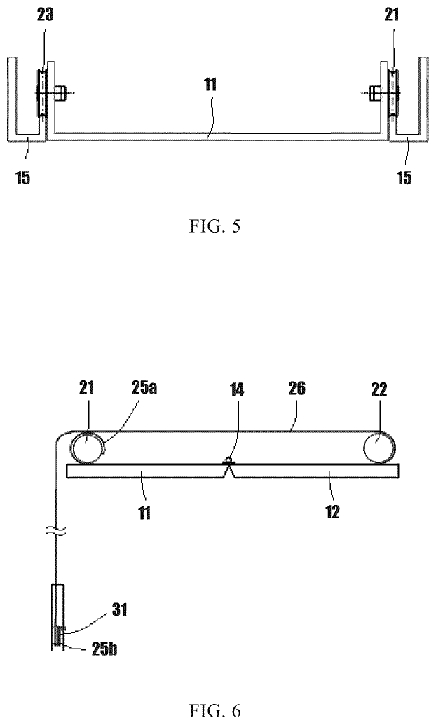

In the operating device 20, the rollers 21 and 23 may be optionally fixed to one of the first panel 11 and the second panel 12. For example, the rollers 21 and 23 may be fixed by any feasible means such as by connecting pieces like bolts or by welding, and may be arranged on opposite sides of the elevator car 103. For example, in the example shown in FIG. 4, the rollers 21 and 23 are fixed to the first panel 11 and arranged opposite to each other along the transverse direction (i.e., the width direction) of the elevator car 103. Referring further to FIG. 5, the roller 21 may be rollably arranged on a ceiling frame 15 located on the right side of the figure, and the roller 23 may be rollably arranged on the ceiling frame 15 located on the left side of the figure. That is, the ceiling frames 15 respectively corresponding to the rollers 21 and 23 may be used as the limitation and support from the guide rails for their rolling movement, and the above ceiling frames 15 are usually fixed to the upper side wall of the elevator car 103. Similarly, the roller 24 may be arranged on the same side as the roller 23 and fixed to the second panel 12, and the roller 24 may rollably move on the ceiling frame 15 located on that side.

For the roller 22, it may be arranged adjacent to the other of the first panel 11 and the second panel 12 (i.e., a panel different from the one discussed above that fixes roller 21 and roller 23 to it), and the roller 22 may be fixed relative to the elevator car 103. For example, the roller 22 may be fixed to the ceiling frame 15 located on the same side as the roller 21 by any feasible means, such as by connecting pieces like bolts or by welding, as schematically shown in FIG. 4.

Generally speaking, the ceiling frame 15 installed on the upper side wall of the elevator car 103 has a relatively strong rigid structure and is mostly configured in a straight line configuration. Therefore, the rollers 21 and 23 may have a collinear arrangement, and the rollers 22 and 24 may also have a collinear arrangement. When performing operations to change the state of the ceiling panel 10, the use of the above arrangement will save both time and labor.

The cable 25 can use any suitable cable as needed, such as steel wire rope, alloy material rope, carbon fiber rope, and the like. Referring to FIGS. 4 and 6, the cable 25 has a first end 25a and a second end 25b. The first end 25a can be fixed to the roller 21, and the second end 25b can be wound around the roller 22 and then arranged at a suitable position in the interior space 104 of the elevator car 103, so as to be provided to the mechanic to perform corresponding operations when needed. In this way, people can open the opening area leading to the elevator car in a convenient, fast, and efficient manner without the need for additional tools such as ladders and operating rods. This not only saves time and effort during installation and maintenance, but also improves system safety, which is particularly beneficial in the event of abnormal or emergency situations with elevator equipment.

By way of exemplary illustration, as used exemplarily herein, the second end 25b may be optionally fixed to the car operation panel box 30 of the elevator car 103. For example, an operating component 31 such as an operating handle can be provided inside the box of the car operation panel box 30, and the second end 25b of the cable 25 can be directly wound around and fixed to the operating component 31. In specific applications, as shown in FIG. 6, by operating the operating component 31, the cable 25 starts to take in or release outward through the second end 25b, thereby changing the current state of the ceiling panel 10 accordingly. For example, when the cable 25 is taking in, the ceiling panel 10 can enter a folded state to open the opening above it, and the folded panel can approach or press against the inner wall of the car. As an optional scenario, by controlling and maintaining the state of the cable 25, both the first panel 11 and the second panel 12 can be kept unfolded to keep the ceiling panel 10 in a normal state. For example, as shown in FIG. 6, a portion of the cable 25 near the second end 25b can be fixed to the operating component 31 and the cable 25 can be kept in a loose or basically loose state. At this point, the first panel 11 and the second panel 12 can be supported by, for example, the respective rollers, on the corresponding ceiling frames 15 to maintain the unfolded state. In addition, in one or some embodiments, the cable 25 can be kept in a stretched state and the first panel 11 and the second panel 12 can be kept unfolded. This helps to reduce the seam between the first panel 11 and the second panel 12 in the normal state, thus achieving a better decorative and aesthetic effect visually.

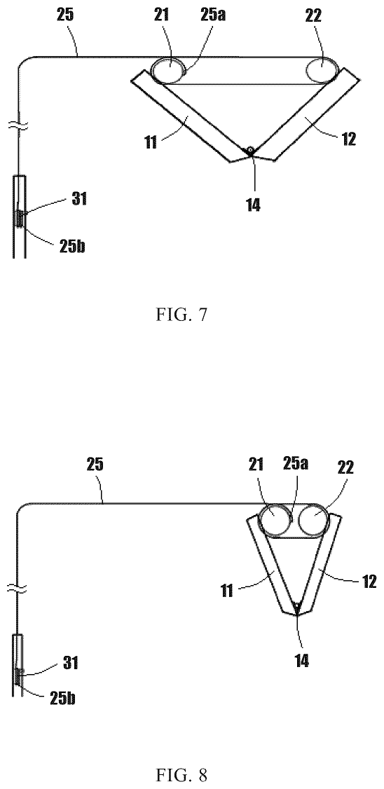

As an alternative solution, in one or some embodiments, a motor and control members (such as toggle switches, buttons, etc.) can be installed inside the car operation panel box 30, and the second end 25b of the cable 25 can be connected to the output end of the motor, so that when needed, the motor can be controlled to operate by operating the above control members. For example, the motor can be started to rotate forward to take in the cable 25, so that the cable 25 can drive the roller 21 to roll towards the roller 22. At this point, the first panel 11 and the second panel 12 can be driven to fold downward as shown in FIGS. 7 and 8, causing the ceiling panel 10 to enter a folded state. FIG. 7 shows the scenario where the panels are partially folded during the above process. FIG. 8 shows the scenario where the panels are completely or substantially folded. At this point, the opening leading to the car roof can be completely or substantially opened, thus providing sufficient space for personnel to enter the top area of the elevator car.

It should be appreciated that the solutions of the present disclosure are exemplified above using specific embodiments. The elevator car ceiling system of the present disclosure may have more implementation modes, and thus the elevator car configured with the ceiling system may also have numerous implementation modes. The elevator car may be of a lightweight type, a heavy-duty type or a low-height type, and one or more elevator cars according to the present disclosure may be arranged in an elevator system according to application needs.

For example, the ceiling panel 10 may be configured with, for example, three or more panel sections, which may be connected by hinge members and in some cases may be folded upwards instead of downwards towards the floor direction of the elevator car 103 as shown in FIGS. 6 to 8. This can be achieved by installing hinge members to the positions on the outer surfaces of these panel sections facing the floor direction and/or between two adjacent panels. When adopting the scheme of folding the panel sections of the ceiling panel 10 upwards, the cable 25 may be optionally kept in a stretched state as shown earlier, so that a force can be applied to these panels to help reduce the seams between adjacent panels in the normal state, thus achieving a more satisfactory decoration appearance of the ceiling.

For another example, these panel sections that constitute the ceiling panel 10 may be changed to be arranged along the longitudinal direction of the elevator car 103, and/or these panel sections may have the same or different configurations from each other. For example, they may be configured to have the same or different widths, and may be made of the same or different materials, such as one or more materials selected from stainless steel, aluminum alloy, and/or plastic. In addition, for these panel sections of the ceiling panel 10, they may also adopt the means of relative translation to achieve the state change of the ceiling panel 10, such as by pulling and translating the first panel above or below the second panel through a cable, thereby forming an opening at the original position of the first panel.

For yet another example, although the arrangement of rollers 23 and 24 facilitates the folding operation of the ceiling panel 10, in one or some embodiments, however, the roller 23 and/or roller 24 may be removed to simplify the structure, that is, allowing only the rollers 21 and 22, and the cable 25 to be used to implement the state change operation of the ceiling panel 10. In practical applications, the rollers mentioned throughout the text may be in the form of a single roller or multiple rollers.

An elevator car ceiling system, an elevator car, and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. An elevator car ceiling system, comprising:
a ceiling panel, arranged below a car roof of an elevator car and having a normal state and a folded state, wherein the ceiling panel comprises a first panel and a second panel connected to each other, and the first panel and the second panel are folded in the folded state to provide an opening to the car roof; and
an operating device, arranged inside the elevator car and connected to the ceiling panel, wherein the operating device is configured for operating to cause the ceiling panel to enter the folded state from the normal state, or to return to the normal state from the folded state.

2. The elevator car ceiling system according to claim 1, wherein the operating device comprises:
a first roller, fixed to one of the first panel and the second panel;
a second roller, arranged on the same side of the elevator car as the first roller, and arranged adjacent to the other of the first panel and the second panel and fixed relative to the elevator car; and
a cable, a first end of which is fixed on the first roller, and a second end of which is arranged in an interior space of the elevator car for operation after winding around the second roller.

3. The elevator car ceiling system according to claim 2, wherein the first panel and the second panel are hingedly connected to each other, and when the first roller is moved in the direction of the second roller by a stretching operation at the second end of the cable, the first panel and the second panel are folded downwardly or upwardly, causing the ceiling panel to enter the folded state.

4. The elevator car ceiling system according to claim 2, wherein the second roller is fixed to a ceiling frame of the elevator car, and the first roller is rollably arranged on the ceiling frame.

5. The elevator car ceiling system according to claim 2, wherein the operating device further comprises:
a third roller, fixed to said one of the first panel and the second panel, and arranged on opposite sides of the elevator car from the first roller; and/or
a fourth roller, fixed to said the other of the first panel and the second panel, and arranged on opposite sides of the elevator car from the second roller.

6. The elevator car ceiling system according to claim 5, wherein the third roller and the fourth roller are rollably arranged on the ceiling frame of the elevator car.

7. The elevator car ceiling system according to claim 2, wherein the first panel and the second panel are hingedly connected to each other and the second end of the cable is fixed in the interior space of the elevator car, causing both the first panel and the second panel remain unfolded in the normal state.

8. The elevator car ceiling system according to claim 7, wherein the second end is fixed inside a car operation panel box of the elevator car.

9. The elevator car ceiling system according to claim 8, wherein an operating handle is provided inside the car operation panel box and the second end is fixed to the operating handle, or a motor and a control member for controlling operation of the motor are provided inside the car operation panel box and the second end is connected to an output end of the motor.

10. The elevator car ceiling system according to claim 1, wherein the first panel and the second panel are arranged along a transverse or longitudinal direction of the elevator car, and/or a width of the first panel is the same as a width of the second panel.

11. An elevator car, wherein the elevator car is configured with an elevator car ceiling system according to claim 1.

12. An elevator system, wherein the elevator system is configured with one or more elevator cars according to claim 11.
